(19) United States
(12) Patent Application Publication
(10) Pub. No.: US 2022/0115646 A1
(43) Pub. Date: Apr. 14, 2022

(54) SILICON/GRAPHENE COMPOSITE ANODE MATERIAL AND METHOD TO MANUFACTURE THE SAME

(71) Applicant: XG SCIENCES, INC., Lansing, MI (US)

(72) Inventors: John Colwell, Lansing, MI (US); Thomas Griffin Ritch, III, Lansing, MI (US); Liya Wang, Lansing, MI (US)

(73) Assignee: XG SCIENCES, INC., Lansing, MI (US)

(21) Appl. No.: 17/421,889

(22) PCT Filed: Jan. 21, 2020
(86) PCT No.: PCT/US2020/014311

§ 371 Date: Jul. 9, 2021

Related U.S. Application Data
(60) Provisional application No. 62/795,143, filed on Jan. 22, 2019.

(51) Int. Cl. H01M 4/36; C01B 32/194; H01M 4/38; H01M 4/587; H01M 4/62; H01M 10/0525

(52) U.S. Cl. CPC H01M 4/366; C01B 32/194; H01M 4/386; H01M 4/587; H01M 2004/027; H01M 10/0525; C01B 2204/22; C01B 2204/04; H01M 4/625

(57) ABSTRACT

Processes and materials are provided for use in Si-based anodes that can improve or extend the cycle life of a battery while also lowering production costs. A composite material design is provided as a porous silicon-graphene-carbon (SiGC) composite particle that is a composed of submicron silicon wrapped with graphene, particulate, flexible conductive additives, and an outer conductive shell or coating made for the purpose of acting as anode material in an electrochemical cell (battery). The tailored composite particle addresses common failure modes to improve cycling performance of silicon by combining multiple mitigation strategies; incorporating intimate graphene coatings to accommodate expansion and protect from solid-electrolyte interphase (SEI) formation; porosity to accommodate expansion; flexible conductive additives to maintain contact during expansion/retraction of the silicon particles and protect the surface from SEI formation; an outer protective shell to hold the composite material together during expansion/retraction; and submicron silicon to prevent pulverization during expansion/retraction.

### RELATED APPLICATIONS

This application claims priority benefit of U.S. Provisional Application Ser. No. 62/795,143 filed 22 Jan. 2019, the contents of which are hereby incorporated by reference.

### TECHNICAL FIELD

The present invention generally relates to the field of materials, and more specifically to improved processes and materials for use in Si-based anodes.

### BACKGROUND

Extensive research and development has been conducted in the past two decades by both academic and industrial communities to develop silicon-based (Si-based) anodes for a new generation of lithium ion batteries. Early efforts were mostly concentrated on pyrolysis of Si-containing polymers, Si/C composites, Si thin films, and Si alloys. Later efforts shifted to nanometer scale (nano) Si, nanowires, nanotubes, and SiOx. Subsequently, porous structures including Si embedded in carbon matrix, core-shell Si/C, porous nanowires and its composites, and three dimensional (3D) porous Si structure/composites received attention. Recently, graphene is being investigated for lithium ion battery (LIB) applications, mostly as a support for nano Si particles or as a conductive additive in electrodes. XG Sciences, Inc. (XGS) has developed a low-cost Si/graphene manufacturing process which coats graphene onto the surface of the silicon in-situ and has demonstrably improved performance as disclosed in U.S. Pat. No. 10,079,389.

A high capacity Si-based anode is an enabling component in advanced batteries that will power future Plug-in and all-electric vehicles (PHEV and EV, respectively). Silicon is considered the most promising candidate due to high capacity and proper working voltage. When paired with a high energy cathode, a high capacity Si-based anode increases the specific energy of lithium ion batteries to greater than 350 Wh/kg, the level needed for electrified transportation. Two major barriers have hindered the development of Si-based anodes for commercial applications: poor cycle life and high synthesis cost.

The poor cycle life of Si-based anodes is due to the fact that Si tends to pulverize during power cycling as a result of substantial volume change (of up to 400%) during charging/discharging of the batteries, which in turn leads to the loss of electrical contact or even disintegration of both Si particles and the electrode coating. Another major failure mechanism is the formation and continued growth of a solid-electrolyte interphase (SEI) layer, which consumes both Li and electrolyte, the supplies of which are limited in field operational cells. This problem is aggravated if Si particles continue to fracture and form new surfaces during cycling.

The high synthesis cost is due to the processes used for the synthesis of Si-based anodes that utilize expensive chemical precursors, exotic synthesis methods, or capital-intensive processes.

Thus, there is a need for improved processes and materials for use in Si-based anodes that can improve or extend the cycle life of the battery while also lowering production costs.

### SUMMARY

A porous silicon-graphene-carbon (SiGC) composite material is provided that includes a plurality of individual silicon particles. The silicon particles are each coated with more than three sheets (>3) of graphene to form a thick graphene layer about the plurality of individual silicon particles and defines pores between the plurality of individual silicon particles. The plurality of individual silicon particles are in simultaneous contact with a flexible conductive network material to form the porous silicon-graphene-carbon (SiGC) composite material.

A method is provided for manufacturing a porous silicon-graphene-carbon (SiGC) composite material. The method includes preparing graphene coated silicon particles from silicon particles each coated with more than three sheets (>3) of graphene, dispersing the graphene coated silicon particles in a first mixed solution of the conductive network material, and spray drying the mixture to generate the spherical porous SiGC composite material.

A lithium secondary battery is provided that includes a negative electrode formed of a negative electrode active material, a conductive agent, and a binder. The negative electrode active material includes the spherical porous SiGC composite material.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1A is a transmission electron microscope (TEM) image of a graphene coating made with approximately 10 layers or sheets of graphene nanoplatelets on a silicon particle in accordance with embodiments of the invention;

FIG. 1B is a transmission electron microscope (TEM) image of a graphene coating made with approximately 42 layers or sheets of graphene nanoplatelets on a silicon particle in accordance with other embodiments of the invention;

FIG. 2 is a scanning electron microscope (SEM) image of an embodiment of the inventive porous silicon-graphene-carbon (SiGC) composite particle;

FIG. 3 is a cross-sectioned schematic view of a porous silicon-graphene-carbon (SiGC) composite material in accordance with embodiments of the invention;

FIG. 4 is a graph of capacity retention versus the number of charge cycles of a lithium secondary battery using the negative electrode formed with embodiments of the inventive porous silicon-graphene-carbon (SiGC) composite particles; and

FIG. 5 is a graph of anode charge capacity versus the number of charge cycles of a lithium secondary battery using the negative electrode formed with the inventive spherical porous silicon-graphene-carbon (SiGC) composite particles.

### DETAILED DESCRIPTION

The present invention has utility as improved processes and materials for use in Si-based anodes that can improve or extend the cycle life of a battery while also lowering production costs. Embodiments of the present invention provide a unique composite material design (referred to herein as a porous silicon-graphene-carbon (SiGC) composite particle) that is a composed of submicron silicon wrapped with graphene, particulate, and flexible conductive additives, and in specific embodiments an outer conductive shell or coating made for the purpose of acting as anode material in an electrochemical cell (battery). In some inventive embodiments the silicon particles are spherical. Silicon anode materials tend to fail due to poor cycle life from silicon particle pulverization and solid-electrolyte interphase (SEI) growth, exacerbated by the silicon particle pulverization. Embodiments of the tailored composite particle addresses the failure modes to drastically improve cycling performance of silicon by combining multiple mitigation strategies; incorporating intimate graphene coatings to accommodate expansion and protect from SEI formation; porosity to accommodate expansion; flexible conductive additives to maintain contact during expansion/retraction of the silicon particles and protect the surface from SEI formation; an outer protective shell to hold the composite material together during expansion/retraction; and submicron silicon to prevent pulverization during expansion/retraction. In the present invention, all materials are necessarily lithium ion (Li+) conductive to enable cycling with low internal particle resistance.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, particle shape is defined as having a shape factor k_{SV} of between 6 and 7 where the shape factor is equal to DSV (Sauter diameter)×the surface density S_{V}. As reference points a perfect sphere has a shape factor of 6 while a dodecahedron has a shape factor of 6.59.

As used herein, Particle Size Distribution D50 is defined as the median diameter or the medium value of the particle size distribution. D50 is the value of the particle diameter at 50% in the cumulative distribution. For example, if D50=5.8 um, then 50% of the particles in the sample are larger than 5.8 um, and 50% are smaller than 5.8 um.

In some inventive embodiments, the silicon particle is composed of a silicon based composite expressed by SiOₓ where x is between 0 and 2 (0≤x≤2). In some inventive embodiments, x is between 0 and 1. The cycling performance of silicon is improved by individually coating submicron Si particles with a thick layer of greater than 3 sheets (>3 sheets) of graphene nanoplatelets, with or without surface functionalization of the nanoplatelets. In a specific inventive embodiment, the layers of graphene range between 1 nm to 50 nm thickness. In other specific inventive embodiments, the layers of graphene range between 4 nm to 15 nm. The submicron silicon particles ensure that the base silicon particle is not pulverized during the expansion and retraction experienced during cycling, and this reduces the surface area available for SEI formation. The graphene layers also have the attribute of being able to slide to accommodate the expansion while still maintaining contact thereby ensuring a conductive pathway while providing surface protection from SEI formation. Conductive additive particles (such as carbon black or graphene) may be incorporated to enhance the particle to particle conductive connectivity in some inventive embodiments. The average particle diameter (D50) of the silicon particles is between 100 nm to 1000 nm. In a specific inventive embodiment, the average particle diameter (D50) of the silicon particles is between 300 nm to 800 nm.

In certain inventive embodiments, following the individual coating of the submicron Si particles, the individual Si/graphene particles are then composited into a porous particle with a Li+ conductive flexible material to form a spherical porous silicon-graphene-carbon (SiGC) composite material. The porous particle in some embodiments has a particle shape that is spherical. The Li+ conductive polymers illustratively including polyacrylonitrile (PAN), polyacrylic acid (PAA), polyvinylidene fluoride (PVDF), polynorbornene with pendent cyclotriphosphazene, polyethylene oxide-polystyrene block copolymers, and those detailed in U.S. Pat. No. 5,789,106; or graphene platelets and may include additional conductive additives that illustratively include the aforementioned carbon black or graphene.

The porous silicon-graphene-carbon (SiGC) composite material has a D50 particle size of between 1 and 30 μm. to accommodate most electrode thickness requirements. In other inventive embodiments the D50 is between 0.1 and 15 μm.

In specific inventive embodiments, a final coating or shell is incorporated which is composed of a Li+ conductive flexible material illustratively including Li+ conductive polymers (PAN, PAA, PVDF, etc.) or graphene platelets to encapsulate the particle and maintain particle integrity and connectivity during cycling. It is appreciated the final coating or shell is readily formed of one of the aforementioned Li+ conductive polymers that are the same, or different than that used to form the underlying porous silicon-graphene-carbon (SiGC) composite in terms of chemical identity, average polymer molecular weight, thickness, or a combination thereof.

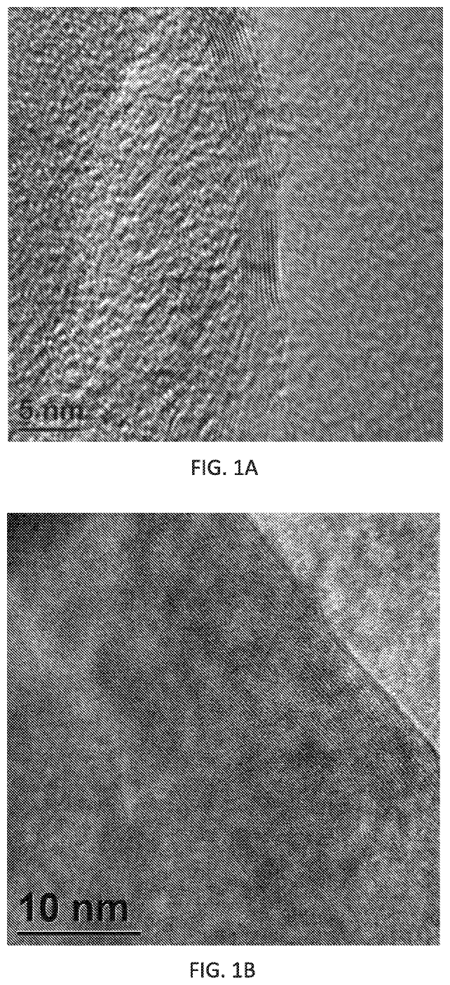

Referring now to the figures, FIG. 1A is a transmission electron microscope (TEM) image of a graphene coating made with approximately 10 layers or sheets of graphene nanoplatelets on a silicon particle. FIG. 1B is a transmission electron microscope (TEM) image of a graphene coating made with approximately 42 layers or sheets of graphene nanoplatelets on a silicon particle.

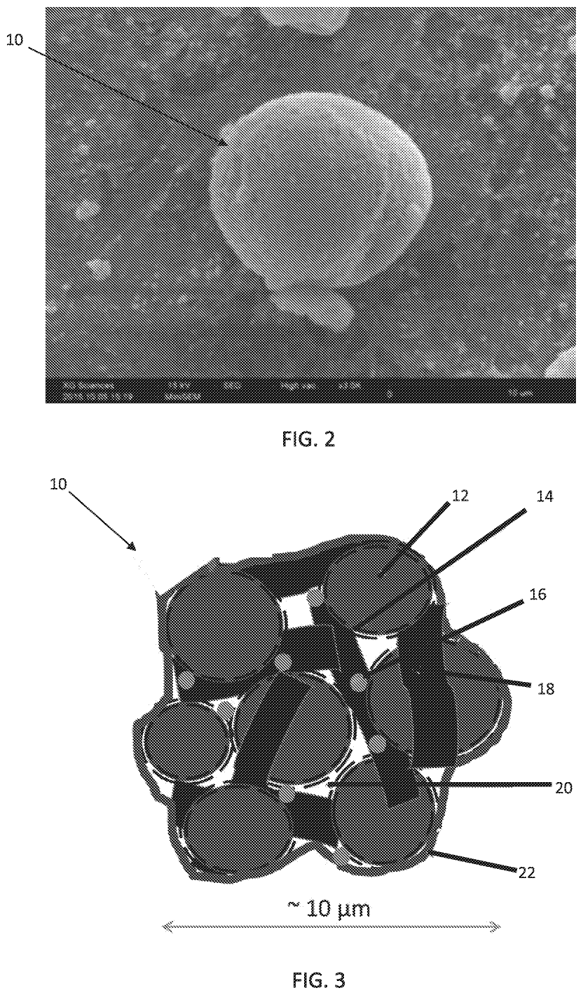

FIG. 2 is a scanning electron microscope (SEM) image of an embodiment of a porous silicon-graphene-carbon (SiGC) composite material 10. FIG. 3 is a cross-sectioned schematic view of a spherical porous silicon-graphene-carbon (SiGC) composite material 10. The composite material 10 is made up of submicron Si particles 12 that withstand volume change stress. In some inventive embodiments, the silicon particles 12 amount to 10 weight percent to 95 weight percent of the overall porous SiGC composite particle 10. A controlled thickness graphene coating 14 applied on the outer surface of the individual Si particles 12 accommodates volume changes, protects the Si particle surface from SEI formation and provides a conductive network. In some inventive embodiments, the graphene content amounts to 1 weight percent to 85 weight percent of the overall spherical porous SiGC composite particle. An additive 16 may be added in specific inventive embodiments to enhance the built-in conductive network. In other inventive embodiments, the conductive additive amounts to 0.5 weight percent to 30 weight percent of the overall porous SiGC composite material and includes at least one of the following: graphene, amorphous carbon, carbon black, carbon fiber, or carbon nanotubes (CNT). A flexible conductive network 18 may be used to maintain the conductive network between the Si particles 12, while accommodating volume changes. In specific inventive embodiments, the flexible conductive network 18 may include functionalization to enhance conductivity and/or adhesion between the Si particles 12. In specific inventive embodiments, the flexible conductive network includes at least one of graphene or a polymer material, where the polymer material is composed of a lithium ion conductive polymer alone, or at least one of the following: polystyrene monomer, a polystyrene oligomer, polyacrylonitrile, polyvinylidene fluoride, a copolymer of polyvinylidene fluoride and polyhexafluoropyrene, polytetrafluoroethylene, polytetrafluouropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polyethylene, polypropylene, polybutylene, polycarbonate; or a combination of any of the aforementioned, with or without the presence of the lithium ion conductive polymer. In a specific inventive embodiment, the flexible conductive network amounts to 0.5 weight percent to 50 weight percent of the overall spherical porous SiGC composite particle.

Intrinsic porosity is provided by the interstitial gaps 20 between the Si particles 12 that accommodates dynamic volume change. In a specific inventive embodiment, the maximum linear extent of a pore is between 1.7 nm and 300 nm and the pores typically are present in an inventive material in a range of 10 volume percent to 50 volume percent based on the total volume of the porous SiGC composite.

An outer coating or shell layer 22 is applied around the aggregate of individual silicon particles 12. The outer coating or shell layer 22 has the strength to hold the silicon particles 12 together and provides surface functionalization to better interact with a binder. The outer coating or shell layer 22 may be composed of graphene, carbon nanotubes, or a polymer material, where the polymer material may include a lithium ion conductive polymer or at least one of the following: polystyrene monomer, a polystyrene oligomer, polyacrylonitrile, polyvinylidene fluoride, a copolymer of polyvinylidene fluoride and polyhexafluoropyrene, polytetrafluoroethylene, polytetrafluouropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polyethylene, polypropylene, polybutylene, and polycarbonate.

A method for manufacturing embodiments of the spherical porous SiGC composite includes 1) preparing the graphene coated silicon particles in the accordance with U.S. Pat. No. 10,079,389 included by reference in its entirety herein; 2) dispersing the graphene coated silicon particles in a first mixed solution of the conductive network material; 3) the optional addition of the conductive additive to the first mixed solution of graphene coated silicon particles and conductive network material; 4) spray drying the mixture to generate the porous particle with a built-in conductive network. In a specific inventive embodiment, a second mixed solution is carried out of dispersing after the spray drying with the conductive material for the outer shell and subsequent spray drying. A drying step may be conducted to remove residual solvent. The drying step may be conducted in the presence of oxygen, in an inert atmosphere, or in a vacuum. The temperature of the drying step is less than 350° C. (<350° C.).

### EXAMPLES

### Example 1

A negative electrode active material is formed using a porous SiGC composite produced by first applying a 15 layer coating of graphene particles via the above process to silicon particles having an average primary silicon particle size of 800 nm. The subsequent SiGC composite is prepared by spray drying a slurry composed of the previously described graphene-coated Si particles and 3% by weight polyacrylic acid (PAA).

### Example 2

A negative electrode is formed using the negative electrode active material of example 1 with a conductive agent, and a binder.

### Example 3

A lithium secondary battery is formed using the negative electrode of example 2.

### Example 4

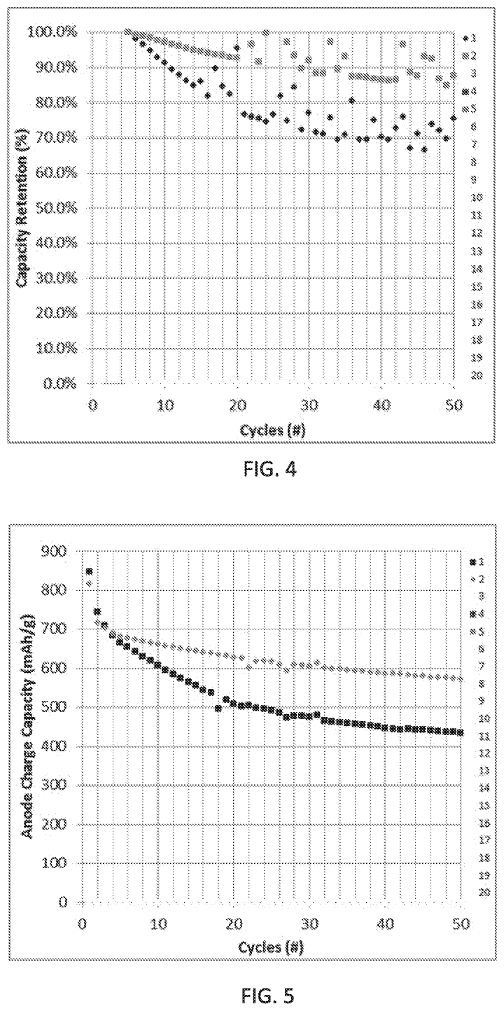

Spray drying improved the cycling performance of a lithium secondary battery with an improvement of 50 cycle capacity retention from 76% to 88% as shown in table 1 and in FIG. 4.

TABLE 1
Spray dried material versus non-sprayed dried material.

| | | | Electrode | | | 50 Cycle |
|---|---|---|---|---|---|---|
| | | | Density | FCC | | Retention |
| # | Color | Description | (g/cc) | (mAh/g) | FCE (%) | (%) |
| 1 | Black | Baseline Si/ | 1.59 | 846 | 90% | 76% |
| | | graphene Mtl | | | | |
| 2 | Gray | Baseline Si/ | 1.56 | 815 | 90% | 88% |
| | | graphene Mtl- | | | | |
| | | sprayed Dried | | | | |

### Example 5

Spray drying improved the capacity retention (%) of a lithium secondary battery with an anode formed with the inventive spherical porous SiGC composite with an improvement of 50 cycle anode charge capacity (mAh/g) from approximately 425 to 575 as shown in FIG. 5.

### OTHER EMBODIMENTS

While at least one exemplary inventive embodiment, has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A porous silicon-graphene-carbon (SiGC) composite material comprising:
a plurality of individual silicon particles, said silicon particles are each coated with more than three sheets (>3) of graphene to form a thick graphene layer about said plurality of individual silicon particles and defining pores between said plurality of individual silicon particles; and
said plurality of individual silicon particles in simultaneous contact with a flexible conductive network material to form the porous silicon-graphene-carbon (SiGC) composite material.

2. The composite material of claim 1 wherein said plurality of individual silicon particles and said plurality of agglomerated silicon particles are composed of a silicon based composite expressed by SiOx (0≤x≤1).

3. The composite material of claim 1 wherein an average particle diameter (D50) of said plurality of individual silicon particles is between 100 nm to 1000 nm.

4. (canceled)

5. The composite material of claim 1 wherein each of said plurality of individual silicon particles is coated with a graphene layer of 1 nm to 50 nm thickness.

6. The composite material of claim 1 wherein each of said plurality of individual silicon particles is coated with a graphene layer of 4 nm to 15 nm thickness.

7. The composite material of claim 1 wherein said plurality of individual silicon particles amount to 10 weight percent to 95 weight percent of the overall porous SiGC composite particle.

8. The composite material of claim 1 wherein graphene content amounts to 1 weight percent to 85 weight percent of the overall porous SiGC composite particle.

9. The composite material of claim 1 further comprising conductive additive particles.

10. The composite material of claim 1 further comprising conductive additive particles that amount to 0.5 weight percent to 30 weight percent of the overall porous SiGC composite particle; and
wherein said conductive additive particles are comprised of at least one of the following: graphene, amorphous carbon, carbon black, carbon fiber, or carbon nanotubes (CNT).

11. The composite material of claim 1 wherein said flexible conductive network materials amount to 0.5 weight percent to 50 weight percent of the overall porous SiGC composite particle.

12. The composite material of claim 1 wherein said flexible conductive network materials further comprise at least one of the following: graphene or a polymer material.

13. (canceled)

14. The composite material of claim 1 wherein an average particle diameter (D50) of the porous SiGC composite material is 1 μm to 30 μm.

15. The composite material of claim 1 wherein a total volume of pores is between 10 volume percent to 50 volume percent based on the total volume of said porous SiGC composite particle and said pores have an average maximal linear extent of 1.7 nm to 300 nm.

16. The composite material of claim 1 further comprising a shell layer coating that bounds the composite material.

17. (canceled)

18. (canceled)

19. The composite material of claim 1 wherein said composite material has a shape factor of between 6 and 7 inclusive.

20. A method of manufacturing a porous silicon-graphene-carbon (SiGC) composite material, said method comprising:
preparing graphene coated silicon particles from silicon particles each coated with more than three sheets (>3) of graphene;
dispersing said graphene coated silicon particles in a first mixed solution of the conductive network material; and
spray drying said mixture to generate the spherical porous SiGC composite material.

21. The method of claim 20 further comprising adding a conductive additive to said graphene coated silicon particles prior to or after said dispersing.

22. The method of claim 20 further comprising dispersing a second mixed solution of a conductive material for an outer shell coating and drying said second mixed solution, said dispersing being after said spray drying.

23. The method of claim 20 further comprising of an additional drying step to remove residual solvent;
wherein said additional drying step is conducted in the presence of oxygen, in an inert atmosphere; or in a vacuum; and
wherein said additional drying step occurs at less than <350′C.

24. (canceled)

25. A negative electrode comprising a negative electrode active material comprising the spherical porous SiGC composite materials of claim 1, a conductive agent, and a binder.

26. (canceled)
